(19) United States
(12) Patent Application Publication
(10) Pub. No.: US 2013/0046610 A1
(43) Pub. Date: Feb. 21, 2013

(54) INDEPENDENT DISCOUNT MANAGEMENT SYSTEM FOR PROVIDING CONSUMERS WITH A DISCOUNT-MAXIMIZED SHOPPING PLAN

(71) Applicant: SUBIL M. ABRAHAM, PLANO, TX (US)

(72) Inventor: SUBIL M. ABRAHAM, PLANO, TX (US)

(73) Assignee: INTERNATIONAL BUSINESS MACHINES CORPORATION, ARMONK, NY (US)

(21) Appl. No.: 13/211,733

(22) Filed: Aug. 17, 2011

(51) Int. Cl. G06Q 30/00

(52) U.S. Cl. 705/14.35; 705/14.1

(57) ABSTRACT

A method for maximizing product discounts can begin with an independent discount management system receiving user-entered shopping data that includes a product selection and/or data for an existing discount. Applicable discount data and discount handling rules can be aggregated from discount providers. A discount-maximized shopping plan can then be synthesized. The discount-maximized shopping plan can define a combination of discount data, date, time, and retailer that affords a maximum discount for each product selection. Upon user-acceptance, an aggregate discount code can be generated for the user-accepted discount-maximized shopping plan and both can be stored. Notification can be received from the retailer that the aggregate discount code has been redeemed. Compensation between the retailer and corresponding discount providers can then be coordinated.

### BACKGROUND

The present invention relates to the field of discount management and, more particularly, to an independent discount management system that provides consumers with a discount-maximized shopping plan.

A wide variety of entities (e.g., retailers, manufacturers, discount clubs, etc.) exist that attempt to entice consumers to purchase specific products by means of offering some type of discount, such as coupons, rebates, and promotions (i.e., buy one, get one free). Often times, discounts from varying sources or discount providers are able to be combined to increase or maximize the consumer's savings on the product.

For example, a consumer is able to use both an in-store coupon provided by the grocery store or retailer in addition to a manufacturer's coupon when purchasing a product. Or, a consumer may purchase a product like a refrigerator of a specific brand because of an in-store promotion offering a percentage off appliances of that brand and then submit a rebate to the manufacturer for the purchase of the refrigerator.

Currently, it is left to the consumer to be aware of the variety discounts and promotions offered, as well as determine how to utilize the available discounts to maximize their savings. A serious limitation to the current approach is the amount of time and/or money a consumer is willing to spend gathering discount information and calculating how to maximize the savings for each item on their shopping list.

This problem is further compounded by the current systems used by discount providers to promote and/or distribute their discount information. Firstly, discounts are provided in various formats (e.g., paper or electronic) and may require the consumer to join a club/group or purchase a membership. Discounts are distributed non-uniformly. For example, it is common for different newspapers to include different sets of coupon flyers and some coupons are offered only in an online format.

Retailers add another level of confusion by offering special days and/or times when the redemption of discounts is handled in a different manner. For example, a specific store may double the value of coupons redeemed on Thursday afternoons.

With this current environment, discount providers struggle to effectively promote products through discounts and consumers struggle to effectively use the available discounts.

### BRIEF SUMMARY

One aspect of the present invention can include a method for maximizing product discounts. Such a method can begin with an independent discount management system receiving user-entered shopping data that includes a product selection and/or data for an existing discount. Discount data and discount handling rules can be aggregated from discount providers for the user-entered shopping data in accordance with pre-existing agreements. A discount-maximized shopping plan can then be synthesized from the aggregated discount data and discount handling rules. The discount-maximized shopping plan can define a combination of discount data, a date, a time, and a retailer that affords a maximum discount for each product selection. Upon user-acceptance of the discount-maximized shopping plan, an aggregate discount code can be generated that represents the aggregated discount data of the user-accepted discount-maximized shopping plan. The aggregate discount code and corresponding discount-maximized shopping plan can be stored. Notification can be received from the retailer that the aggregate discount code has been redeemed in a purchase transaction. Compensation between the retailer and corresponding discount providers can then be coordinated for use of the aggregate discount code for the applicable products in the purchase transaction.

Another aspect of the present invention can include a system for maximizing product discounts. Such a system can include discount provider, retailers, and an independent discount management system. The discount providers can be configured to electronically supply a discount data for a variety of products. The discount data can be redeemable in accordance with discount handling rules. The retailers can have transaction processing systems configured to redeem discount data from the discount providers in accordance with applicable discount handling rules during a purchase transaction for a product. The independent discount management system can be configured to generate a discount-maximized shopping plan that represents a maximum cost savings for user-entered shopping data containing products that are available for purchase from the retailers. The discount-maximized shopping plan can aggregate discount data and discount handling rules from the discount providers and can use a single aggregate discount code to represent the aggregate of discount data. Further, the independent discount management system can operate independent of the discount providers and the retailers.

Yet another aspect of the present invention can include a computer program product that includes a computer readable storage medium having embedded computer usable program code. The computer usable program code can be configured to receive user-entered shopping data that includes a product selection and/or data for an existing discount. The computer usable program code can be configured to aggregate discount data and discount handling rules from discount providers for the received user-entered shopping data in accordance with pre-existing agreements. The computer usable program code can be configured to synthesize a discount-maximized shopping plan from the aggregated discount data and discount handling rules. The discount-maximized shopping plan can define a combination of discount data, a date, a time, and a retailer that affords a maximum discount for each product selection contained in the received user-entered shopping data. The computer usable program code can be then configured to, upon user-acceptance of the contents of the discount-maximized shopping plan, generate an aggregate discount code that represents the aggregated discount data of the user-accepted discount-maximized shopping plan. Then, the computer usable program code can be configured to store the generated aggregate discount code and the corresponding discount-maximized shopping plan. The computer usable program code can be configured to receive notification from the retailer that the aggregate discount code has been redeemed in a purchase transaction. Further, the computer usable program code can be configured to coordinate compensation between the retailer and corresponding discount providers for the use of the aggregate discount code in the purchase transaction for applicable products included in the purchase transaction.

### BRIEF DESCRIPTION OF THE SEVERAL VIEWS OF THE DRAWINGS

FIG. 1 is a schematic diagram of a system illustrating an independent discount management system that provides a consumer with a discount-maximized shopping plan in accordance with embodiments of the inventive arrangements disclosed herein.

FIG. 2 is a flow chart of a method describing the basic interactions between the consumer and discount management system for creation of a discount-maximized shopping plan in accordance with an embodiment of the inventive arrangements disclosed herein.

FIG. 3 is a schematic diagram of a system implementing a resource-conserving technique for as-available data delivery to a mobile device in accordance with an embodiment of the inventive arrangements disclosed herein.

FIG. 4 is a flow chart of a method outlining the basic operation of the discount management system in accordance with embodiments of the inventive arrangements disclosed herein.

FIG. 5 is a flow chart of a method detailing the aggregation of discount data by the discount management system in accordance with embodiments of the inventive arrangements disclosed herein.

FIG. 6 is a flow chart of a method describing the synthesis of the discount-maximized shopping plan by the discount management system in accordance with embodiments of the inventive arrangements disclosed herein.

FIG. 7 is a flow chart of a method illustrating the use of the discount management system during a purchase transaction to validate and provide additional discount data in accordance with embodiments of the inventive arrangements disclosed herein.

### DETAILED DESCRIPTION

The present invention discloses a solution for an independent discount management system that can provide consumers with a discount-maximized shopping plan. From shopping data provided by the consumer, the independent discount management system can aggregate discount data and discount handling rules from multiple discount providers to determine combinations that provide the consumer with maximum savings. These combinations can be presented to the consumer as the discount-maximized shopping plan. A unique aggregate discount code can be used to represent the aggregate of discount data contained in the discount-maximized shopping plan.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

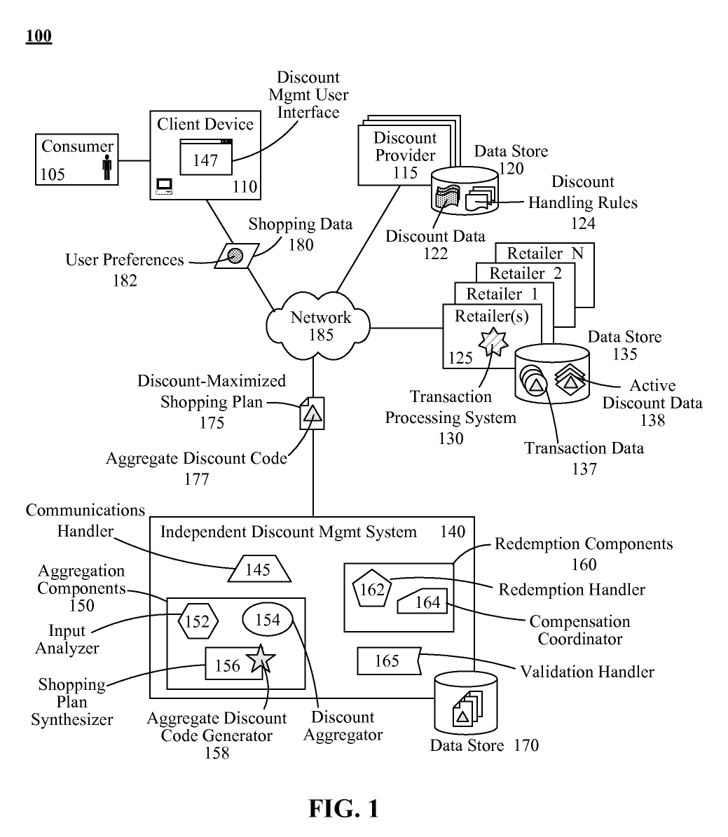

FIG. 1 is a schematic diagram of a system 100 illustrating an independent discount management system 140 that provides a consumer 105 with a discount-maximized shopping plan 175 in accordance with embodiments of the inventive arrangements disclosed herein.

In system 100, the independent discount management system 140 can generate a discount-maximized shopping plan 175 for shopping data 180 provided by a consumer 105. The independent discount management system 140, herein referred to as the discount management system 140, can represent the hardware and/or software components necessary to interact over a network 185 with discount providers 115 to produce the discount-maximized shopping plan 175.

The discount management system 140 can include a communications handler 145, a user interface 147, a group of aggregation components 150, a group of redemption components 160, a validation handler 165, and a data store 170 to house the discount-maximized shopping plans 175.

The communications handler 145 can correspond to a component configured to manage communications over the network 185 with discount providers 115, retailers 125, and the consumer 105 via the user interface 147. The communications handler 145 can generate or package electronic messages in accordance with standardized communication protocols and/or application programming interfaces (APIs) that are supported by the discount providers 115 and retailers 125.

The user interface 147 can be a graphical user interface (GUI) that acts as a means of interaction between the consumer 105 and the discount management system 140. The discount management system 140 can use the user interface 147 to accept shopping data 180 from the consumer 105 as well as present the discount-maximized shopping plan 175.

The consumer 105 can utilize the user interface 147 on a client device 110. The client device 110 can represent a variety of computing devices capable of supporting operation of the user interface 147 and communicating over the network 185. Examples of the client device 110 can include, but are not limited to, a computer, a smart phone, a kiosk, a laptop computer, a portable gaming device, a PDA, and the like.

Shopping data 180 can represent a variety of information such as product selections that the consumer 105 would like discount data 122 or discount data 122 for a discount that they already possess. The specific shopping data 180 collected within the user interface 147 can vary based upon implementation of the discount management system 140. The shopping data 180 can also include user preferences 182 to allow the consumer 105 to add limits to what the discount management system 140 uses to generate the discount-maximized shopping plan 175.

For example, the consumer 105 can select specific discount providers 115 to use or limit the retailers 125 they intend to shop at to a specific area.

In one embodiment, the consumer 105 can provide shopping data 180 by entering and/or selecting products from a list as well as auxiliary details like a specific flavor or brand. In another embodiment, the user interface 147 can provide a shopping cart mechanism for the consumer 105 to collect discount data 122 they intend to use.

In another contemplated embodiment, the discount management system 140 can allow the consumer 105 to upload shopping data 180. For example, the consumer 105 could upload a text file containing their shopping list of products.

In yet another contemplated embodiment, the user preferences 182 can be stored in a user profile (not shown) associated with the consumer 105. Thus, the stored user preferences 182 can be used every time the consumer 105 requests generation of a discount-maximized shopping plan 175.

The aggregation components 150 can then utilize the shopping data 180 to create the discount-maximized shopping plan 175. The aggregation components 150 can represent a group of software components that aggregate discount data 122 and/or discount handling rules 124 from the discount providers 115 to create the discount-maximized shopping plan 175.

A discount provider 115 can represent a business entity that has the authority to offer discount data 122 to consumers 105 and compensate retailers 125 when a consumer 105 redeems the offered discount data 122. Examples of discount providers 115 can include, but are not limited to, a product manufacturer, a retailer 125, a financial institution, a social networking discount service (e.g., GROUPON, FACEBOOK), a discount clearinghouse, and the like.

The discount data 122 can be information about the discounts being offered by discount providers 115 in an electronic format. Examples of discounts that can be stored as discount data 122 can include, but is not limited to, a coupon, a promotion code, a discount code, a gift certificate code, a gift card code, a store credit voucher, a rebate, and the like.

In another contemplated embodiment, discount data 122 can be expanded to include sales data for retailers 125 (i.e., sales prices for products).

Regardless of the format in which the discount provider 115 originally distributed the discount (e.g., paper, electronic, plastic card), the corresponding discount data 122 can be an electronic representation of that discount. The discount data 122 can include details about the discount, such as applicable products, expiration date, quantity, discount amount, retailer 125, and the like.

For example, retailers 125, which can act as discount providers 115, can offer paper coupons by products on the store shelves. The information for these paper coupons, such as product, expiration date, and amount, can be electronically stored in a data store 120 of the discount provider 115 as discount data 122.

A discount provider 115 can also have discount handling rules 124 that affect how discount data 122 is redeemed or handled. For example, many discount providers 115 can specify that their coupon cannot be doubled or applied to multiple of the same products. Also, a specific retailer 125 can offer to match coupon values, effectively offering a coupon of the same value, at specified times during the week. Thus, the discount handling rules 124 can affect the overall amount that a discount is worth.

The aggregation components 150 can include an input analyzer 152, a discount aggregator 154, a shopping plan synthesizer 156, and an aggregate discount code generator 158. The input analyzer 152 can be the component 150 configured to process the shopping data 180 provided by the consumer 105.

Processing of the shopping data 180 by the input analyzer 152 can identify the products, discount providers 115, and/or retailers 125 as well as restrictions from the user preferences 182. The input analyzer 152 can then pass the processed information to the discount aggregator 154 for the purpose of creating queries that can be used to aggregate applicable discount data 122 and/or discount handling rules 124 from the discount providers 115.

The discount aggregator 154 can be the component 150 configured to gather discount data 122 and/or discount handling rules 124 for the shopping data 180 from the discount providers 115. The discount aggregator 154 can create one query per product per discount provider 115.

For example, when there are three discount providers 115 and two products in the shopping data 180, the discount aggregator 154 can create three queries for each product, or six queries total.

The discount aggregator 154 can generate queries that conform to a query language supported by the target discount provider 115. The discount aggregator 154 can use the communications handler 145 to send the queries to the discount providers 115 to be run. When the results are received from the discount providers 115, the discount aggregator 154 can group the discount data 122 and applicable discount handling rules 124 according to product and/or retailer 125.

The aggregated discount data 122 and applicable discount handling rules 124 can then be passed to the shopping plan synthesizer 156. The shopping plan synthesizer 156 can represent the component 150 configured to create the discount-maximized shopping plan 175 from the discount data 122 and applicable discount handling rules 124 aggregated for the shopping data 180 entered by the consumer 105.

The shopping plan synthesizer 156 can utilize a variety of techniques and/or algorithms for determining combinations of discount data 122, discount handling rules 124, and retailer 125 and calculating the savings provided by each combination for each product contained in the shopping data 180 and with respect to any restrictions expressed in the user preferences 182. For the sake of simplicity, each combination can be referred to herein as a “shopping strategy”.

For example, based on the aggregated shopping data 122, the shopping plan synthesizer 156 can determine that Product G has three possible combinations or shopping strategies. The first shopping strategy can be to purchase Product G at Retailer J 125 using a manufacturer's 115 coupon 122, saving 15 cents. The second shopping strategy can be to purchase Product G on a Wednesday at Retailer Q 125 to take advantage of Retailer Q's 125 double coupon value promotion using the same manufacturer's 115 coupon 122, saving a total of 30 cents. Lastly, the third shopping strategy can be to use the same manufacturer's 115 coupon 122 for Product G at Retailer Y 125 along with an in-store coupon 122 provided by Retailer Y 125 for 10 cents, resulting in a savings of 25 cents.

As a minimum, the discount-maximized shopping plan 175 can include the shopping strategy that provides the maximum savings for each product. Using the example above, the discount-maximized shopping plan 175 can include the second listed shopping strategy for Product G. The configuration and/or presentation of data comprising the discount-maximized shopping plan 175 as well as functions that the consumer 105 can perform in the user interface 147 upon that data can vary depending upon the specific implementation of the discount management system 140.

For example, the discount-maximized shopping plan 175 can include multiple shopping strategies, like those above, to allow the consumer 105 to further customize the contents according to their current situation.

Additionally, the shopping plan synthesizer 156 can suggest discount handling rules 124 from a retailer 125 that the consumer 105 should try to utilize. For example, a retailer 125 may have a discount handling rule 124 for providing a 10% discount on purchases of $50 or more. The shopping plan synthesizer 156 can highlight this opportunity for additional savings in the discount-maximized shopping plan 175

Regardless of the specific implementation, the consumer 105 can be required to confirm or accept the contents of the discount-maximized shopping plan 175. Acceptance can signify the consumer's 105 intention to utilize the aggregated discount data 122 contained in the discount-maximized shopping plan 175. Further, acceptance can trigger the shopping plan synthesizer 156 to invoke the aggregate discount code generator 158 to create an aggregate discount code 177 for the discount-maximized shopping plan 175.

The aggregate discount code generator 158 can be a software component configured to generate an aggregate discount code 177 in accordance with predefined methods and/or algorithms. The aggregate discount code 177 can be a single code that represents the aggregated discount data 122 of the discount-maximized shopping plan 175 (i.e., a meta-discount code).

The aggregate discount code 177 can have various formats depending upon the specific implementation of the discount management system 140 and/or client device 110 of the consumer 105. Examples of the aggregate discount code 177 can include, but are not limited to, a two-dimensional graphical code (e.g., bar code, QR code, etc.), an alpha-numeric sequence (i.e., code key or cryptographic sequence), a radio frequency identification (RFID) code, and the like.

The format of the aggregate discount code 177 can conform to existing standards already in use by retailers 125. For example, a bar code can be a universal product code (UPC) or European article number (EAN) (now referred to as an international article number).

Further, the aggregate discount code 177 can be provided to the consumer 105 in various formats. For example, the aggregate discount code 177 can be presented to the consumer 105 electronically as a coupon having a bar code, which the consumer 105 can then print a physical copy to be used at the applicable retailers 125. Alternately, the consumer 105 can display the bar code of the electronic coupon upon the screen of a smart phone 110, which can then be scanned by the retailer 125.

In another contemplated embodiment, the discount management system 140 can provide consumers 105 with a plastic card having a RFID tag. The aggregate discount code 177 can then be an alpha-numeric sequence associated with the RFID tag of the specific consumer 105. Such an embodiment can also be applied to utilize magnetic strip technology.

Both the aggregate discount code 177 and discount-maximized shopping plan 175 can be stored in a data store 135 accessible by the discount management system 140. In another embodiment, the aggregate discount code 177 and/or discount-maximized shopping plan 175 can be stored with relation to or within a user profile (not shown) associated the consumer 105.

Once the consumer 105 receives the aggregate discount code 177, the consumer 105 can then visit those retailers 125 listed in the discount-maximized shopping plan 175 to purchase their selected products. A retailer 125 can represent a business entity that sells products. A retailer 125 can operate from a physical and/or electronic storefront (i.e., e-commerce business).

The retailer 125 can utilize a transaction processing system 130 like a point-of-sale system that captures transaction data 137 in a data store 135. The transaction data 137 can represent the details regarding the products being purchased by the consumer 105 as well as the discount data 122 or aggregate discount code 177 redeemed.

Depending upon the specific configuration and/or implementation, the transaction processing system 130 can also utilize a set of active discount data 138 that can be stored local to the retailer 125. The active discount data 138 can represent a subset of the discount data 122 supplied by the discount providers 115 that is currently valid.

For example, Retail A 125 can elect to only honor discount data 122 from discount providers 115 A, W, and Z. Therefore, the active discount data 138 used by Retailer A 125 can be comprised of discount data 122 from only discount providers 115 A, W, and Z.

While not explicitly required, the active discount data 138 can simply provide a faster means for the transaction processing system 130 to determine the validity of discount data 122 used with a purchase. Therefore, the aggregate discount code generator 158 can be further configured to provide the aggregate discount code 177 and, optionally, the discount data 122 of the corresponding discount-maximized shopping plan 175 to retailers 125 for inclusion in their active discount data 138, when necessary.

During general operation, the transaction processing system 170 can determine the validity of an aggregate discount code 177 being redeemed for a purchase in the same manner as existing discount data 122 is currently determined. In another embodiment, the transaction processing system 170 can utilize the discount management system 140 to validate usage of the aggregate discount code 177. In such an embodiment, the discount management system 140 can utilize the aggregation components 150 upon the transaction data 137 of the current purchase to identify any other discount data 122 that can be applied to the purchase.

For example, the consumer 105 may have purchased items that they didn't include when generating their discount-maximized shopping plan 175. The discount management system 140 can be configured to identify and apply discount data 122 for these extra items in real or near real-time during check-out, further increasing the consumer's 105 savings.

When an aggregate discount code 177 is redeemed at a retailer 125, the discount management system 140 can be notified by the retailer 125 or their transaction processing system 130. This notification can be similar to methods currently used for discount redemption between retailers 125 and discount providers 115.

For example, the transaction processing system 130 can process the day's transaction data 137 after business hours to generate and send redemption messages to the discount providers 115 and/or discount management system 140 for discount data 122 or aggregate discount codes 177 that were redeemed.

The discount management system 140 can handle such notifications using its redemption components 160 that can include a redemption handler 162 and a compensation coordinator 164. The redemption handler 162 can be the component 160 configured to process in-coming notifications from retailers 125 regarding the redemption of aggregate discount codes 177.

The redemption handler 162 can analyze the transaction data 137 included in the notification to determine what discount data 122 and/or discount handling rules 124 of the discount-maximized shopping plan 175 were satisfied by the purchase.

It is important to note that the consumer 105 can make a purchase for a product that does not fully utilize the discount data 122 and/or discount handling rules 124 defined in the discount-maximized shopping plan 175. For example, the discount-maximized shopping plan 175 can indicate that Product G should be purchased at Retailer Q 125 on a Thursday to double the value of Coupon M 122. However, the consumer 105 may, instead, purchase Product G at Retailer Y 125 on Wednesday and still use the aggregate discount code 177.

As such, the value of Coupon M 122 can still be applied to the purchase at Retailer Y 125, however, the discount handling rule 124 for the doubling of its value is not satisfied. This can also be true should the consumer 105 purchase Product G on a day other than Thursday at Retailer Q 125.

Thus, the redemption handler 162 can correlate the transaction data 137 for purchases using the aggregate discount code 177 with the discount data 122 contained in the discount-maximized shopping plan 175 to determine which, if any, discount data 122 and/or discount handling rules 124 were satisfied.

Further, the redemption handler 162 can mark the discount data 122 and/or discount handling rules 124 that were satisfied as having been redeemed or used in the discount-maximized shopping plan 175. The specific handling of the redeemed discount data 122 in the discount-maximized shopping plan 175 can vary based upon configuration and/or implementation of the discount management system 140.

For example, the redemption handler 162 can remove or deactivate redeemed discount data 122. Once all the discount data 122 of a discount-maximized shopping plan 175 has been redeemed, the redemption handler 162 can then delete the discount-maximized shopping plan 175 and its corresponding aggregate discount code 177 from the data store 170.

In another embodiment, the redemption handler 162 can simply determine which discount data 122 was redeemed in the current purchase and not perform any other action upon the redeemed discount data 122. That is, the redemption handler 162 can be used to verify satisfaction of the redemption conditions for the discount data 122.

In such an embodiment, the virtual nature of the aggregate discount code 177 can translate into offering the consumer 105 an unlimited supply of an item of discount data 122. This can thought of as being the same as the consumer 105 printed multiple coupons 122 from a discount provider's 115 Web site. Therefore, from the perspective of the consumer 105, the consumer 105 can be able to redeem the same coupon 122 in different purchases at the same or different retailers 125, until the coupon 122 reaches its expiration date.

Such an embodiment can be beneficial to the consumer 105 by allowing the consumer 105 to create a discount-maximized shopping plan 175 for products they always purchase and other discount-maximized shopping plans 175 for products to be purchased for a specific week or occasion. Further, the discount management system 140 can include additional tools that identify product usage trends to assist the consumer 105 in grouping products into discount-maximized shopping plans 175.

Once the redemption handler 162 has determined which discount data 122 was redeemed in the purchase, the information can be passed to the compensation coordinator 164. The compensation coordinator 164 can be the component 160 configured to handle communicating the redemption of the discount data 122 to the appropriate discount providers 115 on behalf of the retailers 125 where the aggregate discount code 177 was redeemed.

The compensation coordinator 164 can provide the redeemed discount data 122 along with the retailer's 125 information over the network 185 to the discount providers 115 in accordance with existing methods. For example, the compensation coordinator 164 can create an electronic message conforming to the standards and/or protocols currently used for this type of communication between the retailers 125 and discount providers 115.

It is well known in the art that discount data 122 typically have expiration dates. Thus, the inherent expiration dates associated with discount data 122 can also affect the validity of the discount-maximized shopping plan 175. Therefore, the validity of a discount-maximized shopping plan 175 can be constrained by the earliest expiration date of an item of discount data 122 that it contains.

For example, a discount-maximized shopping plan 175 containing three items of discount data 122 having expiration dates of January 2012, October 2011, and November 2011, respectively, can be considered to have an expiration date of October 2011, the earliest chronological expiration date.

It is possible, then, for a consumer 105 to be unable to redeem their aggregate discount code 177 by the earliest expiration date contained in the discount-maximized shopping plan 175. This can cause a problem for the consumer 105 and the discount management system 140 should the consumer 105 attempt to redeem an aggregate discount code 177 having out-of-date discount data 122.

Therefore, the validation handler 165 can be the component of the discount management system 140 that monitors the validity of the discount data 122 contained in the stored discount-maximized shopping plans 175. The validation handler 165 can be invoked by the discount management system 140 at predetermined time intervals (e.g., daily at 9 PM) or in response to notification of expiration by the discount provider 115.

Function of the validation handler 165 can vary depending upon the specific implementation of the discount management system 140 and/or data access agreements with the discount providers 115. For example, the validation handler 165 can be configured to query the discount data 122 of the discount providers 115 at the end of a month to generate a comprehensive list (not shown) of discount data 122 items that will expire in the subsequent month. The validation handler 165 can then, on those specific dates, evaluate the contents of the discount-maximized shopping plans 175 contained in the data store 175.

When discount data 122 of a discount-maximized shopping plan 175 is found that has reached its expiration, the validation handler 165 can deactivate or remove that discount data 122 from the discount-maximized shopping plan 175 as well as send the consumer 105 a message or email about the expiration.

In addition to helping consumers 105 maximize their shopping savings, the discount management system 140 can provide benefits to the discount providers 115 and retailers 125 as well. Since the discount data 122 is handled virtually and electronically (even when the consumer 105 redeems a paper print-out of the aggregate discount code 177, retailers 125 can no longer be required to collect and account for physical copies of redeemed discount data 122, which are often lost.

Further, the redemption of out-of-date or counterfeit discount data 122 by workers of the retailers 125 can be greatly reduced. Since a single aggregate discount code 177 can take the place of many physical coupons 122, the cashier can spend less time when redeeming the aggregate discount code 177, which means faster check-out lines and happier consumers 105.

The discount management system 140 can further provide discount providers 115 with greater visibility of their discount data 122 to a wider audience of consumers 105. The discount management system 140 can also provide discount providers 115 and retailers 125 with additional trend and metrics data from an independent source, which can assist in marketing efforts.

As used herein, presented data stores 120, 135, and 170 can be physical or virtual storage space configured to store digital information. Data stores 120, 135, and 170 can be physically implemented within any type of hardware including, but not limited to, a magnetic disk, an optical disk, a semiconductor memory, a digitally encoded plastic memory, a holographic memory, or any other recording medium. Data stores 120, 135, and 170 can be a stand-alone storage unit as well as a storage unit formed from a plurality of physical devices. Additionally, information can be stored within data stores 120, 135, and 170 in a variety of manners. For example, information can be stored within a database structure or can be stored within one or more files of a file storage system, where each file may or may not be indexed for information searching purposes. Further, data stores 120, 135, and/or 170 can utilize one or more encryption mechanisms to protect stored information from unauthorized access.

The network 185 can include any hardware/software/and firmware necessary to convey data encoded within carrier waves. Data can be contained within analog or digital signals and conveyed though data or voice channels. Network 185 can include local components and data pathways necessary for communications to be exchanged among computing device components and between integrated device components and peripheral devices. Network 185 can also include network equipment, such as routers, data lines, hubs, and intermediary servers which together form a data network, such as the Internet. Network 185 can also include circuit-based communication components and mobile communication components, such as telephony switches, modems, cellular communication towers, and the like. Network 185 can include line based and/or wireless communication pathways.

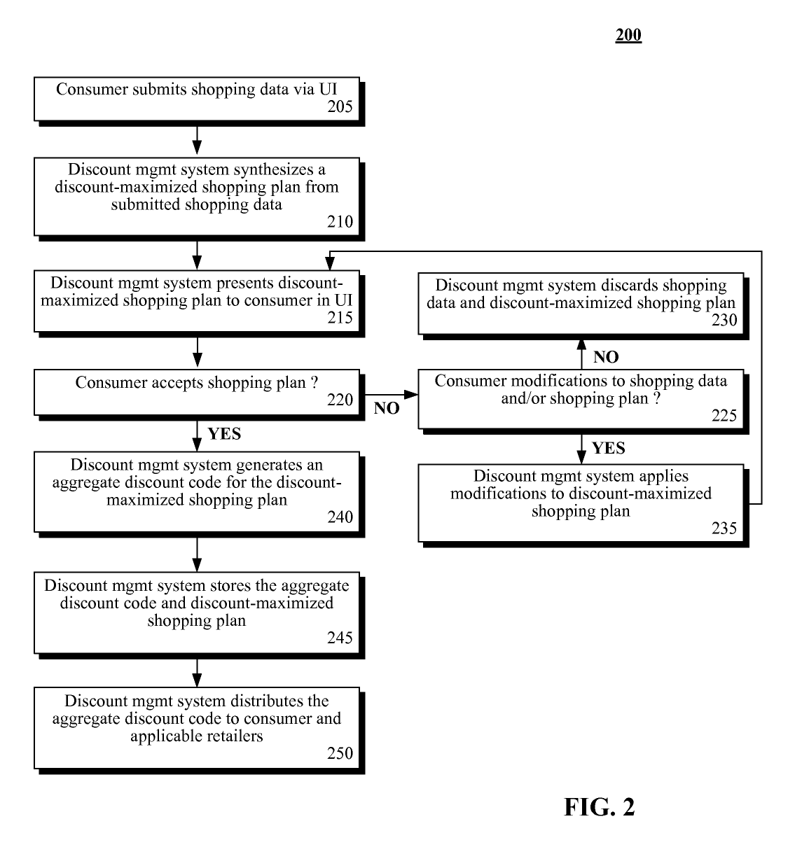

FIG. 2 is a flow chart of a method 200 describing the basic interactions between the consumer and discount management system for creation of a discount-maximized shopping plan in accordance with embodiments of the inventive arrangements disclosed herein. Method 200 can be performed within the context of system 100.

Method 200 can begin in step 205 where the consumer can submit shopping data to the discount management system via the user interface. Submission of shopping data can require registration of the consumer with the discount management system.

The discount management system can then synthesize a discount-maximized shopping plan for the submitted shopping data in step 210. In step 215, the discount management system can present the discount-maximized shopping plan to the consumer in the user interface.

In step 220, it can be determined if the consumer accepts the contents of the discount-maximized shopping plan. When the consumer does not accept the discount-maximized shopping plan, it can be determined if the consumer has made modifications to the shopping data and/or contents of the discount-maximized shopping plan in step 225.

When the consumer has not modified the shopping data and/or contents of the discount-maximized shopping plan, step 230 can be performed where the discount management system can discard the submitted shopping data and generated discount-maximized shopping plan. Step 230 can essentially assume rejection of the discount-maximized shopping plan in its entirety on the part of the discount management system. Method 200 can restart at step 205 after of step 230.

When the consumer has modified the shopping data and/or the contents of the discount-maximized shopping plan, the discount management system can apply the modifications to the discount-maximized shopping plan in step 235. Depending upon the type of modifications, the discount-maximized shopping plan can be re-synthesized as part of step 235. From step 235, flow can return to step 215 where the modified discount-maximized shopping plan can be presented to the consumer in the user interface.

When the consumer accepts the discount-maximized shopping plan, step 240 can execute where the discount management system can generate an aggregate discount code for the discount-maximized shopping plan. The aggregate discount code and discount-maximized shopping plan can then be stored by the discount management system in step 245.

In step 250, the discount management system can distribute the aggregate discount code to the consumer and applicable retailers. Distribution to the applicable retailers can be required for those retailers who keep a local listing of valid discount data like the active discount data 138 shown in system 100 of FIG. 1.

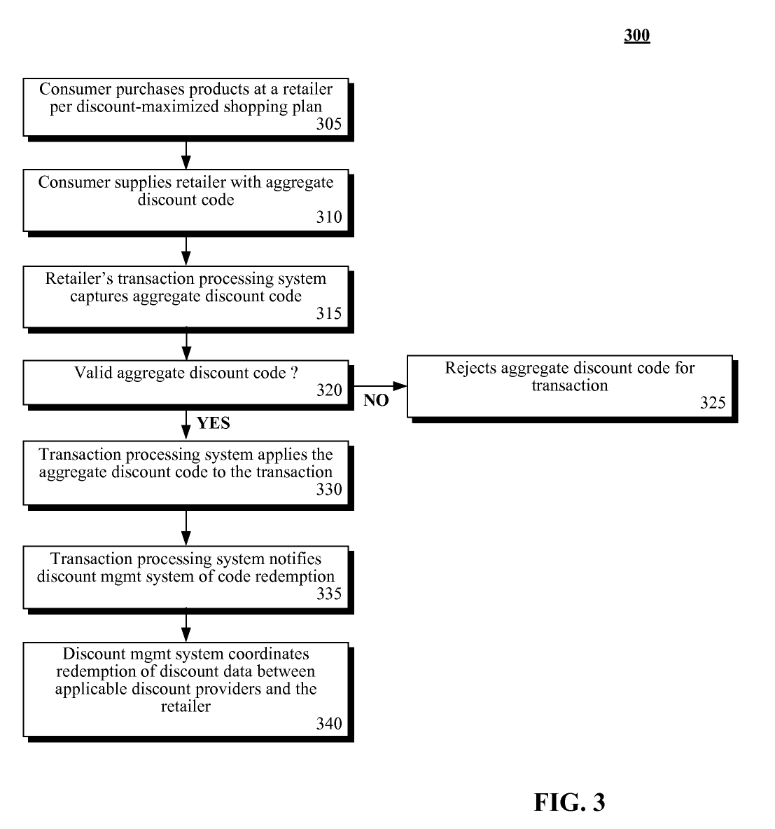

FIG. 3 is a flow chart of a method 300 detailing the basic interactions between the retailer and discount management system for the redemption of an aggregate discount code in accordance with embodiments of the inventive arrangements disclosed herein. Method 300 can be performed within the context of system 100 and/or in conjunction with method 200.

Method 300 can begin in step 305 where the consumer can purchase products at a retailer in accordance with their discount-maximized shopping plan. The consumer can then provide the retailer with the aggregate discount code in step 310.

In step 315, the transaction processing system of the retailer can capture the aggregate discount code. The validity of the captured aggregate discount code can be determined in step 320. Method 300 can assume that the transaction processing system of the retailer performs the validation of the aggregate discount code locally.

When the transaction processing system determines that the aggregate discount code is invalid, the aggregate discount code can be rejected for the transaction in step 325. When the transaction processing system determines that the aggregate discount code is valid, step 330 can be performed where the transaction processing system can apply the aggregate discount code to the transaction.

In step 335, the transaction processing system can notify the discount management system that the aggregate discount code was redeemed. The discount management system can then coordinate the redemption of the discount data between the applicable discount providers and the retailer in step 340.

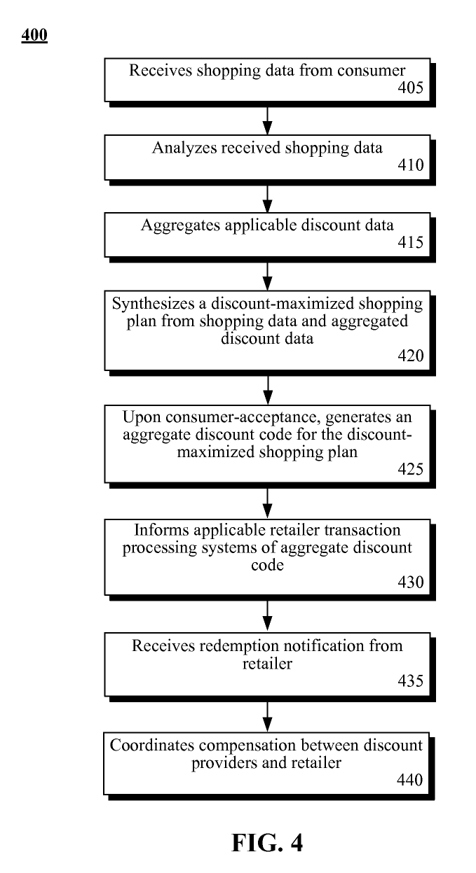

FIG. 4 is a flow chart of a method 400 outlining the basic operation of the discount management system in accordance with embodiments of the inventive arrangements disclosed herein. Method 400 can be performed within the context of system 100and/or in conjunction with methods 200 and/or 300.

Method 400 can begin in step 405 where shopping data can be received from the consumer. The received shopping data can be analyzed in step 410. In step 415, discount data applicable to the shopping data can be aggregated.

A discount-maximized shopping plan can then be synthesized in step 420 from the shopping data and aggregated discount data. Upon acceptance of the discount-maximized shopping plan by the consumer, an aggregate discount code can be generated for the discount-maximized shopping plan in step 425.

In step 430, applicable retailer transaction processing systems can be informed of the aggregate discount code. At a later time, a redemption notification can be received from a retailer in step 435. In step 440, compensation for the redemption of the aggregate discount code can be coordinated between the discount providers and retailer.

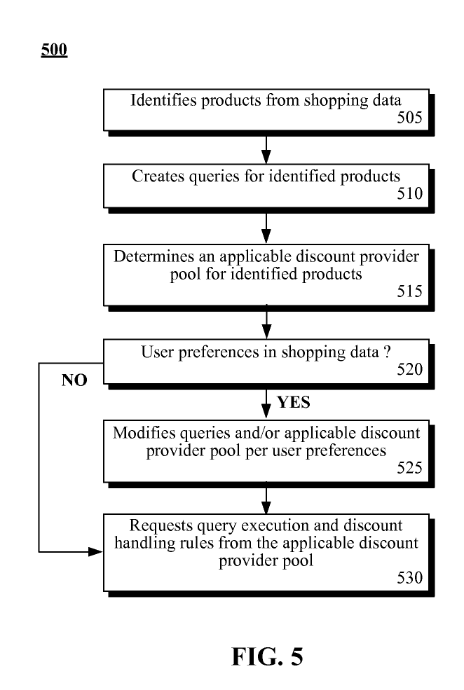

FIG. 5 is a flow chart of a method 500 detailing the aggregation of discount data by the discount management system in accordance with embodiments of the inventive arrangements disclosed herein. Method 500 can be performed within the context of system 100 and/or in conjunction with methods 200 and/or 400.

Method 500 can begin in step 505 where products can be identified from the submitted shopping data. It should be noted that this can be applicable whether the shopping data comprises product selections or discount data.

For example, when the shopping data contains coupon information for coupons that the consumer already possesses, the discount management system can identify the products to which those coupons apply in order to provide additional discount data that can further increase the consumer's savings.

Queries can be created for the identified products in step 510. In step 515, an applicable discount provider pool can be determined for the identified products. That is, if the identified products are grocery items, then the discount providers to be queried should be those who carry grocery items.

In step 520, it can be determined if the shopping data includes user preferences. When user preferences exist, then the queries and/or the applicable discount provider pool can be modified accordingly in step 525.

For example, in the user preferences, the consumer can express that Retailer K should be excluded. Thus, Retailer K can be removed from the applicable discount provider pool in step 525.

Upon completion of step 525 or when user preferences are determined to not exist in step 520, step 530 can execute where the discount management system can request the applicable discount provider pool to execute the queries as well as provide their discount handling rules.

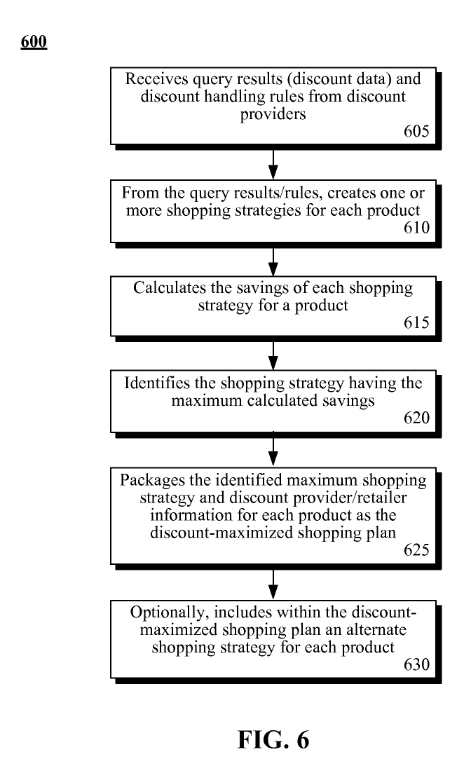

FIG. 6 is a flow chart of a method 600 describing the synthesis of the discount-maximized shopping plan by the discount management system in accordance with embodiments of the inventive arrangements disclosed herein. Method 600 can be performed within the context of system 100 and/or in conjunction with methods 200 and/or 400.

Method 600 can begin in step 605 where the discount management system can receive query results comprised of discount data and discount handling rules from discount providers. The query results and discount handling rules can be the result of a previous request, such as that made in step 530 of method 500.

From the query results and discount handling rules, one or more shopping strategies can be created in step 610. As previously discussed, a shopping strategy can represent a specific combination of discount data, discount handling rules, and retailer. Thus, the quantity of query results returned can govern the quantity of shopping strategies that can be created for a product.

In step 615, the savings of each shopping strategy can be calculated for a product. The shopping strategy having the maximum calculated savings can then be identified in step 620.

In step 625, the identified shopping strategy for each product along with the discount provider and/or retailer information can be packaged as the discount-maximized shopping plan. Optionally, step 630 can be performed where an alternate shopping strategy, when available, for each product can be included in the discount-maximized shopping plan.

For example, the shopping strategy having the maximum savings may only be redeemable on a specific day of the week, whereas the shopping strategy providing the second highest savings can be redeemed any day of the week. Including multiple shopping strategies in the discount-maximized shopping plan can provide the consumer with the ability to customize the discount-maximized shopping plan to fit their lifestyle.

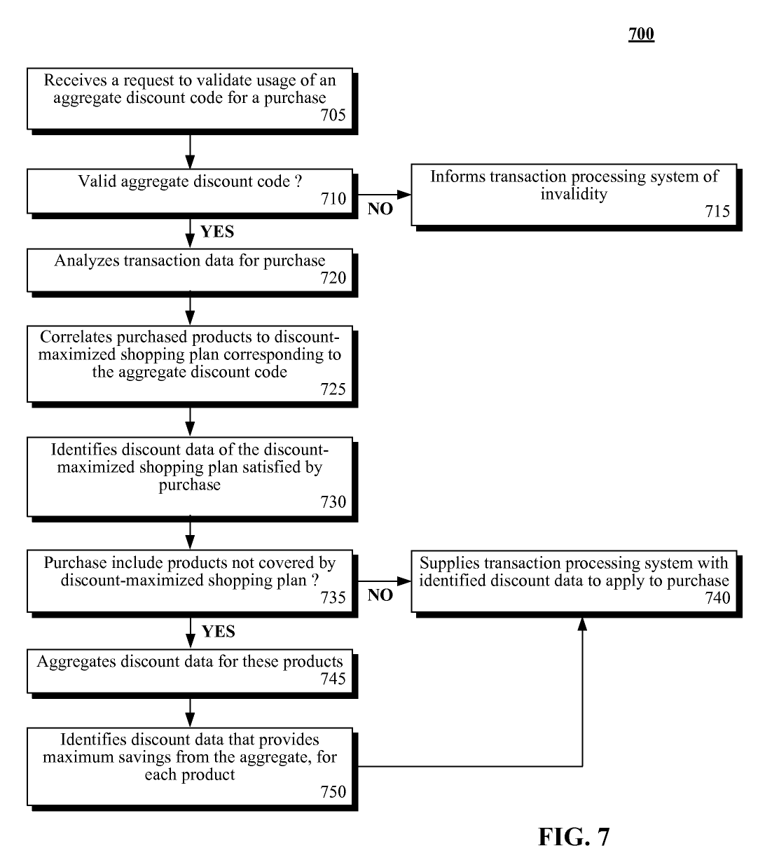

FIG. 7 is a flow chart of a method 700 illustrating the use of the discount management system during a purchase transaction to validate and provide additional discount data in accordance with embodiments of the inventive arrangements disclosed herein. Method 700 can be performed within the context of system 100 and/or in conjunction with methods 300 and/or 400.

Method 700 can begin in step 705 where the discount management system can receive a request to validate the usage of an aggregate discount code for a purchase. The validity of the aggregate discount code can be determined in step 710.

When the aggregate discount code is determined to be invalid, the requesting transaction processing system can be informed of the invalidity in step 715. When the aggregate discount code is determined to be valid, step 720 can execute where transaction data for the purchase can be analyzed.

The purchased products can be correlated to the discount-maximized shopping plan that corresponds to the aggregate discount code in step 725. In step 730, the discount data of the discount-maximized shopping plan that is satisfied by the purchase can be identified.

In step 735, it can be determined if the purchase includes products not covered by the discount-maximized shopping plan. When the purchase does include additional products, discount data for the additional products can be aggregated in step 740.

In step 745, the discount data that provides the maximum savings can be identified from the aggregate for each product. Upon completion of step 745 or when the purchase is determined to not contain additional products, the identified discount data can be supplied to the transaction processing system for application to the purchase.

It is important to note that, when the purchase includes additional items, the discount data supplied to the transaction processing system includes the discount data from the discount-maximized shopping plan as well as the discount data identified “on-the-fly” for the additional products.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for maximizing product discounts comprising:
receiving of user-entered shopping data by an independent discount management system, wherein said user-entered shopping data comprises at least one of a product selection and data for an existing discount;
aggregating a plurality of discount data and discount handling rules from a plurality of discount providers for the received user-entered shopping data, wherein said independent discount management system has a pre-existing agreement with the plurality of discount providers to access said plurality of discount data and discount handling rules;
synthesizing a discount-maximized shopping plan from the aggregated discount data and discount handling rules, wherein the discount-maximized shopping plan defines a combination of discount data, a date, a time, and a retailer that affords a maximum discount for each product selection contained in the received user-entered shopping data;
upon user-acceptance of contents of the discount-maximized shopping plan, generating an aggregate discount code for the discount-maximized shopping plan, wherein said aggregate discount code represents the aggregated discount data of the user-accepted discount-maximized shopping plan;
storing the generated aggregate discount code and the corresponding discount-maximized shopping plan;
receiving notification from the retailer that the aggregate discount code has been redeemed in a purchase transaction; and
coordinating compensation between the retailer and corresponding discount providers for use of the aggregate discount code in the purchase transaction, wherein said compensation is only coordinated for discount data applicable to products included in the purchase transaction.

2. The method of claim 1, wherein aggregating the discount data and discount handling rules further comprises:
analyzing contents of the received user-entered shopping data;
creating a plurality of queries from the analyzed user-entered shopping data, wherein each query represents a request for discount data from a discount provider, wherein said plurality of queries conform to at least one standardized query language utilized by the plurality of discount providers;
determining from the plurality of discount providers a pool of discount providers applicable for the plurality of queries, wherein each discount provider in the pool is usable for at least one query in the plurality of queries; and
conveying the plurality of queries to the pool of discount providers for processing, wherein each discount provider in the pool returns query results.

3. The method of claim 2, wherein prior to the conveyance of the plurality of queries, said method further comprises:
identifying an existence of user preferences within the analyzed user-entered shopping data, wherein a user preference defines a restriction to at least one of a descriptive data for the product selection, the retailer where the aggregate discount code is to be redeemed, and discount providers allowed in the pool of discount providers; and
when user preferences exist, modifying at least one of a query and the pool of discount providers in accordance with the user preferences.

4. The method of claim 1, wherein synthesis of the discount-maximized shopping plan further comprises:
for each product selection in the user-entered shopping data, creating at least one shopping strategy from the aggregated discount data and discount handling rules, wherein each shopping strategy defines at least a specific combination of discount data, discount handling rules, and the retailer to be used for purchase;
calculating a savings for the at least one shopping strategy;
selecting from the at least one shopping strategy a shopping strategy having a maximum calculated savings; and
packaging the selected shopping strategy for each product selection as the discount-maximized shopping plan.

5. The method of claim 4, wherein packaging of the selected shopping strategies further comprises:
when one unselected shopping strategy exists for the product selection, designating the unselected shopping strategy as an alternate shopping strategy;
when more than one unselected shopping strategies exist for the product selection, identifying the shopping strategy having the maximum calculated savings from the more than one unselected shopping strategies remaining;
designating the identified shopping strategy as the alternate shopping strategy for the product selection; and
including the alternate shopping strategy with the selected shopping strategy for the product selection in the discount-maximized shopping plan.

6. The method of claim 4, wherein packaging of the selected shopping strategies further comprises:
for each shopping strategy contained in the discount-maximized shopping plan, providing a means for user-configuration of the discount-maximized shopping plan, wherein said user-configuration allows for at least one of an acceptance of the selected shopping strategy, a rejection of the selected shopping strategy, and a request to view unselected shopping strategies for the product selection, when available.

7. The method of claim 1, wherein coordinating compensation further comprises:
correlating at least one product in the purchase transaction to a corresponding section of the discount-maximized shopping plan associated with the aggregate discount code;
for each correlated product, identifying discount data within the corresponding section that is satisfied by the purchase transaction;
grouping the identified discount data satisfied by the purchase transaction according to discount provider;
encapsulating the grouped discount data in a redemption message, wherein the redemption message identifies the retailer requiring compensation; and
conveying said redemption message to the corresponding discount provider on behalf of the retailer.

8. The method of claim 1, wherein receiving notification occurs in at least one of real-time and near real-time of the purchase transaction, said method further comprises:
identifying within transaction data associated with the purchase transaction at least one product not covered by the discount-maximized shopping plan;
aggregating the plurality of discount data for the identified at least one product;
determining from the aggregated discount data an item of discount data providing a maximum savings for the at least one product, where the item of discount data is honored by the retailer; and
conveying the determined item of discount data to the retailer for application to the purchase transaction.

9. The method of claim 1, further comprising:
at predetermined time intervals, ascertaining a validity of unredeemed discount data contained within the discount-maximized shopping plan with respect to a current date;
when an element of discount data contained within the aggregated discount data is invalid, removing said invalid discount data from the discount-maximized shopping plan; and
notifying a creator of the discount-maximized shopping plan to the removal of the invalid discount data.

10. A system for maximizing product discounts comprising:
a plurality of discount providers configured to electronically supply a plurality of discount data for a plurality of products, wherein said plurality of discount data is redeemable in accordance with a plurality of discount handling rules;
a plurality of retailers having transaction processing systems configured to redeem discount data from the plurality of discount providers in accordance with applicable discount handling rules during a purchase transaction for a product; and
an independent discount management system configured to generate a discount-maximized shopping plan representing a maximum cost savings for user-entered shopping data representing products available for purchase from at least one of the plurality of retailers, wherein the discount-maximized shopping plan aggregates discount data and discount handling rules from the plurality of discount providers, wherein a single aggregate discount code is used to represent the aggregate of discount data contained in the discount-maximized shopping plan, and, wherein the independent discount management system operates independent of the plurality of discount providers and the plurality of retailers.

11. The system of claim 10, wherein the plurality of discount data comprises a coupon, a promotion code, a discount code, a gift certificate code, a gift card code, a store credit voucher, and a rebate, wherein said plurality of discount data is able to be distributed to consumers in at least one of a physical and an electronic format.

12. The system of claim 10, wherein the plurality of discount providers comprises a product manufacturer, a financial institution, a retailer, a social networking discount service, and a third-party clearinghouse.

13. The system of claim 10, wherein the independent discount management system further comprises:
a user interface configured to act as an interaction mechanism for the independent discount management system, wherein said user interface accepts user-entered input and presents the discount-maximized shopping plan;
a communications handler configured to manage an exchange of electronic communications for the independent discount management system, wherein said communications handler utilizes a plurality of standardized communications protocols and application programming interfaces (APIs);
a group of aggregation components comprising:
an input analyzer configured to analyze the user-entered shopping data to identify products, applicable discount providers, and user preferences, wherein the applicable discount providers is a subset of the plurality of discount providers;
a discount aggregator configured to aggregate discount data from the applicable discount providers for the identified products, wherein said aggregation is modifiable by the user preferences;
a shopping plan synthesizer configured to create the discount-maximized shopping plan from the discount data aggregated by the discount aggregator;
a group of redemption components comprising:
a redemption handler configured to process redemption notifications from the plurality of discount providers, wherein a redemption notification indicates a submission of the aggregate discount code to the retailer for at least one product; and
a compensation coordinator configured to submit compensation requests to applicable discount providers on behalf of the discount provider in response to a redemption notification, wherein a compensation request identifies discount data satisfied by the purchase transaction for which the retailer is entitled reimbursement from the discount provider.

14. The system of claim 10, further comprising:
a data store configured to store discount-maximized shopping plans with associated aggregate discount codes; and
a validation handler configured to periodically assess a validity of discount data contained within the stored discount-maximized shopping plans that has yet to be redeemed, wherein the validation handler removes invalid data from a stored discount-maximized shopping plan.

15. The system of claim 10, wherein the plurality of discount providers and plurality of retailers are registered with the independent discount management system, wherein the independent discount management system acts as a virtual centralized repository of the plurality of discount data and discount handling rules for the plurality of discount provider regardless of a format in which an element of discount data was originally distributed by a discount provider.

16. A computer program product comprising a computer readable storage medium having computer usable program code embodied therewith, the computer usable program code comprising:
computer usable program code configured to receive user-entered shopping data, wherein said user-entered shopping data comprises at least one of a product selection and data for an existing discount;
computer usable program code configured to aggregate a plurality of discount data and discount handling rules from a plurality of discount providers for the received user-entered shopping data, wherein a pre-existing agreement with the plurality of discount providers provides access to said plurality of discount data and discount handling rules;
computer usable program code configured to synthesize a discount-maximized shopping plan from the aggregated discount data and discount handling rules, wherein the discount-maximized shopping plan defines a combination of discount data, a date, a time, and a retailer that affords a maximum discount for each product selection contained in the received user-entered shopping data;
computer usable program code configured to, upon user-acceptance of contents of the discount-maximized shopping plan, generate an aggregate discount code for the discount-maximized shopping plan, wherein said aggregate discount code represents the aggregated discount data of the user-accepted discount-maximized shopping plan;
computer usable program code configured to store the generated aggregate discount code and the corresponding discount-maximized shopping plan;
computer usable program code configured to receive notification from the retailer that the aggregate discount code has been redeemed in a purchase transaction; and
computer usable program code configured to coordinate compensation between the retailer and corresponding discount providers for use of the aggregate discount code in the purchase transaction, wherein said compensation is only coordinated for discount data applicable to products included in the purchase transaction.

17. The computer program product of claim 16, wherein aggregating the discount data and discount handling rules further comprises:
computer usable program code configured to analyze contents of the received user-entered shopping data;
computer usable program code configured to create a plurality of queries from the analyzed user-entered shopping data, wherein each query represents a request for discount data from a discount provider, wherein said plurality of queries conform to at least one standardized query language utilized by the plurality of discount providers;
computer usable program code configured to determine from the plurality of discount providers a pool of discount providers applicable for the plurality of queries, wherein each discount provider in the pool is usable for at least one query in the plurality of queries; and
computer usable program code configured to convey the plurality of queries to the pool of discount providers for processing, wherein each discount provider in the pool returns query results.

18. The computer program product of claim 16, wherein synthesis of the discount-maximized shopping plan further comprises:
computer usable program code configured to, for each product selection in the user-entered shopping data, create at least one shopping strategy from the aggregated discount data and discount handling rules, wherein each shopping strategy defines at least a specific combination of discount data, discount handling rules, and the retailer to be used for purchase;
computer usable program code configured to calculate a savings for the at least one shopping strategy;
computer usable program code configured to select from the at least one shopping strategy a shopping strategy having a maximum calculated savings; and
computer usable program code configured to package the selected shopping strategy for each product selection as the discount-maximized shopping plan.

19. The computer program product of claim 16, wherein coordinating compensation further comprises:
computer usable program code configured to correlate at least one product in the purchase transaction to a corresponding section of the discount-maximized shopping plan associated with the aggregate discount code;
computer usable program code configured to, for each correlated product, identify discount data within the corresponding section that is satisfied by the purchase transaction;
computer usable program code configured to group the identified discount data satisfied by the purchase transaction according to discount provider;
computer usable program code configured to encapsulate the grouped discount data in a redemption message, wherein the redemption message identifies the retailer requiring compensation; and
computer usable program code configured to convey said redemption message to the corresponding discount provider on behalf of the retailer.

20. The computer program product of claim 16, further comprising:
computer usable program code configured to, at predetermined time intervals, ascertain a validity of unredeemed discount data contained within the discount-maximized shopping plan with respect to a current date;
computer usable program code configured to, when an element of discount data contained within the aggregated discount data is invalid, remove said invalid discount data from the discount-maximized shopping plan; and
computer usable program code configured to notify a creator of the discount-maximized shopping plan to the removal of the invalid discount data.

21. A computer system for maximizing product discounts, the computer system comprising:
one or more processors, one or more computer-readable memories, and one or more computer-readable, tangible storage devices;
program instructions, stored on at least one of the one or more storage devices for processing by at least one of the one or more processors via at least one of the one or more memories, to receive of user-entered shopping data by an independent discount management system, wherein said user-entered shopping data comprises at least one of a product selection and data for an existing discount;
program instructions, stored on at least one of the one or more storage devices for processing by at least one of the one or more processors via at least one of the one or more memories, to aggregate a plurality of discount data and discount handling rules from a plurality of discount providers for the received user-entered shopping data, wherein said independent discount management system has a pre-existing agreement with the plurality of discount providers to access said plurality of discount data and discount handling rules;
program instructions, stored on at least one of the one or more storage devices for processing by at least one of the one or more processors via at least one of the one or more memories, to synthesize a discount-maximized shopping plan from the aggregated discount data and discount handling rules, wherein the discount-maximized shopping plan defines a combination of discount data, a date, a time, and a retailer that affords a maximum discount for each product selection contained in the received user-entered shopping data;
program instructions, stored on at least one of the one or more storage devices for processing by at least one of the one or more processors via at least one of the one or more memories, to, upon user-acceptance of contents of the discount-maximized shopping plan, generate an aggregate discount code for the discount-maximized shopping plan, wherein said aggregate discount code represents the aggregated discount data of the user-accepted discount-maximized shopping plan;
program instructions, stored on at least one of the one or more storage devices for processing by at least one of the one or more processors via at least one of the one or more memories, to store the generated aggregate discount code and the corresponding discount-maximized shopping plan;
program instructions, stored on at least one of the one or more storage devices for processing by at least one of the one or more processors via at least one of the one or more memories, to receive notification from the retailer that the aggregate discount code has been redeemed in a purchase transaction; and
program instructions, stored on at least one of the one or more storage devices for processing by at least one of the one or more processors via at least one of the one or more memories, to coordinate compensation between the retailer and corresponding discount providers for use of the aggregate discount code in the purchase transaction, wherein said compensation is only coordinated for discount data applicable to products included in the purchase transaction.

22. The computer system of claim 21, wherein the program instructions to aggregate the discount data and discount handling rules:
analyzes contents of the received user-entered shopping data;
creates a plurality of queries from the analyzed user-entered shopping data, wherein each query represents a request for discount data from a discount provider, wherein said plurality of queries conform to at least one standardized query language utilized by the plurality of discount providers;
determines from the plurality of discount providers a pool of discount providers applicable for the plurality of queries, wherein each discount provider in the pool is usable for at least one query in the plurality of queries; and
conveys the plurality of queries to the pool of discount providers for processing, wherein each discount provider in the pool returns query results.

23. The computer system of claim 21, wherein the program instructions to synthesize the discount-maximized shopping plan:
for each product selection in the user-entered shopping data, creates at least one shopping strategy from the aggregated discount data and discount handling rules, wherein each shopping strategy defines at least a specific combination of discount data, discount handling rules, and the retailer to be used for purchase;
calculate a savings for the at least one shopping strategy;
select from the at least one shopping strategy a shopping strategy having a maximum calculated savings; and
package the selected shopping strategy for each product selection as the discount-maximized shopping plan.

24. The computer system of claim 21, wherein the program instructions to coordinate compensation:
correlates at least one product in the purchase transaction to a corresponding section of the discount-maximized shopping plan associated with the aggregate discount code;
for each correlated product, identifies discount data within the corresponding section that is satisfied by the purchase transaction;
groups the identified discount data satisfied by the purchase transaction according to discount provider;
encapsulates the grouped discount data in a redemption message, wherein the redemption message identifies the retailer requiring compensation; and
conveys said redemption message to the corresponding discount provider on behalf of the retailer.

25. The computer system of claim 21, wherein a receiving of notification occurs in at least one of real-time and near real-time of the purchase transaction, said computer system further comprising:
program instructions, stored on at least one of the one or more storage devices for processing by at least one of the one or more processors via at least one of the one or more memories, to identify within transaction data associated with the purchase transaction at least one product not covered by the discount-maximized shopping plan;
program instructions, stored on at least one of the one or more storage devices for processing by at least one of the one or more processors via at least one of the one or more memories, to aggregate the plurality of discount data for the identified at least one product;
program instructions, stored on at least one of the one or more storage devices for processing by at least one of the one or more processors via at least one of the one or more memories, to determine from the aggregated discount data an item of discount data providing a maximum savings for the at least one product, where the item of discount data is honored by the retailer; and
program instructions, stored on at least one of the one or more storage devices for processing by at least one of the one or more processors via at least one of the one or more memories, to convey the determined item of discount data to the retailer for application to the purchase transaction.
